(19) United States
(12) Patent Application Publication
(10) Pub. No.: US 2024/0020142 A1
(43) Pub. Date: Jan. 18, 2024

(54) DETERMINING VIRTUAL MACHINE CONFIGURATION BASED ON APPLICATION SOURCE CODE

(71) Applicant: Dell Products L.P., Round Rock, TX (US)

(72) Inventors: Kartik Jindgar, New Delhi (IN); Jahangeer Pasha Mohammed, Milton (CA)

(21) Appl. No.: 17/867,181

(22) Filed: Jul. 18, 2022

(51) Int. Cl. G06F 9/455; G06F 8/41

(52) U.S. Cl. CPC G06F 9/45558; G06F 8/427; G06F 2009/4557

(57) ABSTRACT

Methods, apparatus, and processor-readable storage media for determining a virtual machine configuration based on application source code are provided herein. An example computer-implemented method includes parsing source code of an application to determine one or more features of the application; providing the one or more features to at least one machine learning model, wherein the machine learning model is trained based at least in part on historical usage data associated with one or more virtual machines configured for one or more other applications; obtaining, from the at least one machine learning model, one of a plurality of virtual machine configurations for the application; and initiating a configuration of at least one virtual machine for the application based at least in part on the virtual machine configuration obtained from the at least one machine learning model.

### FIELD

The field relates generally to information processing systems, and more particularly to configuring virtual machines (VMs) in such systems.

### BACKGROUND

Information processing systems increasingly utilize reconfigurable virtual resources to meet changing user needs in an efficient, flexible and cost-effective manner. For example, a hypervisor can create and allocate resources (e.g., compute, storage, memory, and/or networking resources) of a physical host to one or more VMs. Such VMs can be used to deploy one or more applications.

### SUMMARY

Illustrative embodiments of the disclosure provide techniques for determining a VM configuration based on application source code. An exemplary computer-implemented method includes parsing source code of an application to determine one or more features of the application; providing the one or more features to at least one machine learning model, wherein the machine learning model is trained based at least in part on historical usage data associated with one or more VMs configured for one or more other applications; obtaining, from the at least one machine learning model, one of a plurality of VM configurations for the application; and initiating a configuration of at least one virtual machine for the application based at least in part on the virtual machine configuration obtained from the at least one machine learning model.

Illustrative embodiments can provide significant advantages relative to conventional techniques for determining VM capacity. For example, technical problems associated with determining a VM configuration for an application are mitigated in one or more embodiments by automatically extracting one or more features of the application using an automated source code analysis and determining a VM configuration for the application by applying one or more machine learning techniques to the extracted features of the application.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for determining a VM configuration based on application source code in an illustrative embodiment.

FIG. 2 shows a process for creating a training dataset in an illustrative embodiment.

FIG. 3 shows a process for determining a VM configuration for an application in an illustrative embodiment.

FIG. 4 shows a flow diagram of a process for determining VM configuration based on application source code in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Automated platforms can provide users with easy and convenient means to procure VMs for hosting their respective applications. However, the convenience of such platforms has contributed, at least in part, to an underutilization of resources associated with such VMs. For instance, users frequently request VMs having initial resource configurations that may not be suitable for their respective needs (e.g., a resource configuration for a given VM may have too many or too little resources). VMs having too little resources are often upscaled to avoid negatively impacting a business. However, it is less common for a given VM to be downscaled when resource demands decrease and/or when the initial configuration includes more resources than are required. This can affect the system performance as the underlying hardware resources (e.g., compute and storage resources) may be underutilized. This is particularly problematic when the ability to add new resources to the system is limited (e.g., due to semiconductor chip shortages).

Specifying a configuration of a VM for a given application can be based on a variety of factors. Such factors can include one or more of: a size of the given application, a complexity of the given application, a number of components of the given application, a number and/or types of services of the given application, traffic handled by the given application, historical usage data related to one or more VMs previously used to run the given application, and one or more VMs that run similar types of given applications.

Monitoring tools running on one or more servers can provide data indicating an extent of a usage of resources (e.g., random access memory (RAM) consumption, storage usage, failures, and/or peak traffic duration). In some instances, features related to an application and its existing deployed resources can generally be obtained from one or more configuration management databases (CMDBs), and these features can assist in determining an efficient VM configuration, but are often ignored due to the technological challenges in collecting and analyzing such data.

One or more embodiments described herein can automatically determine a resource configuration for a VM by analyzing source code of an application and applying a machine learning (ML) model that is trained based on historical usage data associated with one or more other VMs.

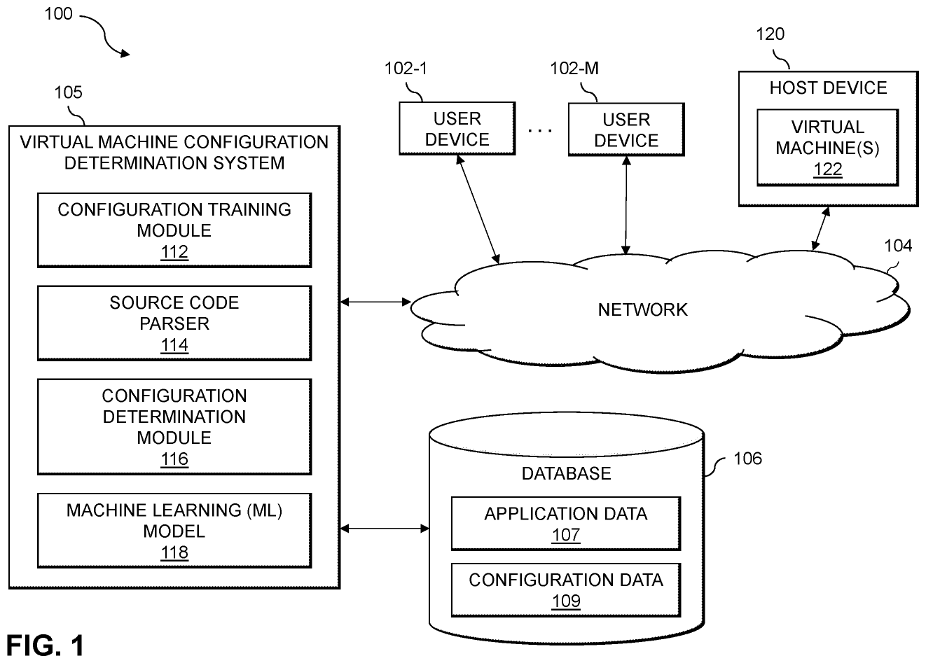

FIG. 1 shows a computer network (also referred to herein as an information processing system) 100 configured in accordance with an illustrative embodiment. The computer network 100 comprises a plurality of user devices 102-1, . . . 102-M, collectively referred to herein as user devices 102 and one or more host devices 120. The user devices 102 and host devices 120 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a VM configuration determination system 105.

The user devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The host devices 120 may be implemented in a manner similar to the user devices 102. The host devices 120, in some embodiments, implement one or more VMs 122 of a compute services platform or other type of processing platform. The host devices 120 in such an arrangement illustratively provide compute services such as execution of one or more applications on behalf of each of one or more users (e.g., associated with respective ones of the user devices 102 and/or host devices 120), where such applications may include one or more applications running in the VMs 122, including potentially the VMs 122 themselves.

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the VM configuration determination system 105 can have at least one associated database 106 configured to store data pertaining to, for example, application data 107 and/or configuration data 109. For example, the application data 107 can comprise details related to software components of an application, a size of an application, a technology stack, and/or a type of an application.

An example database 106, such as depicted in the present embodiment, can be implemented using one or more storage systems associated with the VM configuration determination system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the VM configuration determination system 105 are one or more input-output devices, which illustratively comprise keyboards, displays or other types of input-output devices in any combination. Such input-output devices can be used, for example, to support one or more user interfaces to the VM configuration determination system 105, as well as to support communication between the VM configuration determination system 105 and other related systems and devices not explicitly shown. As an example, the VM configuration determination system 105 can be implemented within and/or communicate with a cloud platform that can configure and provide VMs for deploying one or more applications.

Additionally, the VM configuration determination system 105 in the FIG. 1 embodiment is assumed to be implemented using at least one processing device. Each such processing device generally comprises at least one processor and an associated memory, and implements one or more functional modules for controlling certain features of the VM configuration determination system 105.

More particularly, the VM configuration determination system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises RAM, read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the VM configuration determination system 105 to communicate over the network 104 with the user devices 102, and illustratively comprises one or more conventional transceivers.

The VM configuration determination system 105 further comprises a configuration training module 112, a source code parser 114, and a configuration determination module 116.

Generally, the configuration training module 112 trains an ML model 118 to determine a VM configuration for a particular application. In some examples, the ML model 118 can comprise a classification model, such as a boosted gradient model or a random forest of trees model. In some examples, a boosted gradient model includes an ensemble of prediction models, which are typically decision trees. In some examples, a random forest of trees model is constructed as a multitude of decision trees at training time, and the output of the random forest of trees model is the class selected by most trees.

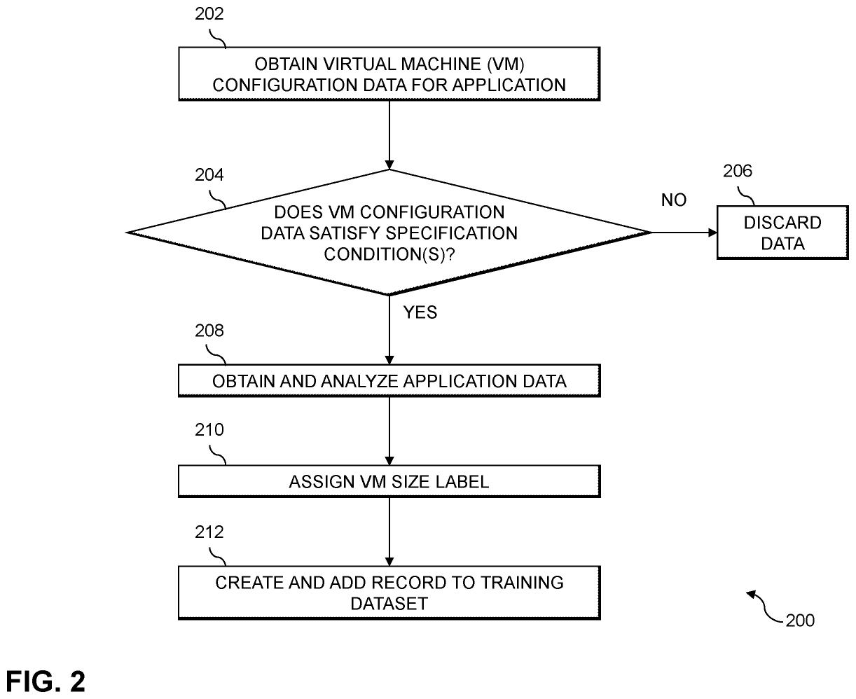

For example, the ML model 118 can be trained in a supervised manner using a training dataset generated based at least in part on historical data related to applications and corresponding VM configurations, as discussed further below in conjunction with FIG. 2. It is to be appreciated that the configuration training module 112, in some embodiments, can train a plurality of ML models 118. For example, the plurality of ML models can correspond to respective types of resources, as discussed in more detail elsewhere herein.

The source code parser 114 can analyze source code of one or more applications and generate respective application summaries or records and can store the application summaries in the database(s) 106 as application data 107. A given application summary can provide details related to the application type (e.g., monolithic, microservice, web application, and a library), a size of the application, and a complexity of the application, for example. Optionally, the source code parser 114 can append additional information to one or more of the application summaries, including information related to application criticality and/or traffic volume. The configuration data 109 can include the VM configurations, and possibly usage information, for the respective application summaries. The configuration training module 112 can train the ML model 118 based on such information. Additional description of a process for creating a training dataset in accordance at least some embodiments is described in conjunction with FIG. 2, for example.

In some embodiments, the VM configuration determination system 105 obtains details related to a new application (e.g., in conjunction with a request from a user for a VM configuration for the new application). In such embodiments, the source code parser 114 can analyze the source code of the new application and generate an application summary. Additional details related to the application (e.g., provided by a user) can be appended to the application summary, if available. The configuration determination module 116 applies the ML model 118 to determine a VM configuration for the new application, as described in further detail elsewhere herein.

It is to be appreciated that this particular arrangement of elements 112, 114, 116 and 118 illustrated in the VM configuration determination system 105 of the FIG. 1 embodiment is presented by way of example only, and alternative arrangements can be used in other embodiments. For example, the functionality associated with the elements 112, 114, 116 and 118 in other embodiments can be combined into a single module, or separated across a larger number of modules. As another example, multiple distinct processors can be used to implement different ones of the elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for VM configuration determination system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the VM configuration determination system 105 and database(s) 106 can be on and/or part of the same processing platform.

Exemplary processes utilizing at least a portion of elements 112, 114, 116 and 118 of an example VM configuration determination system 105 in computer network 100 will be described in more detail with reference to, for example, the flow diagrams of FIGS. 2-4.

FIG. 2 shows a process 200 for creating a training dataset in an illustrative embodiment. It is to be understood that this particular process 200 is only an example, and additional or alternative processes can be carried out in other embodiments. In this embodiment, the process 200 includes steps 202 through 212. In some embodiments, the process 200 is assumed to be performed by the VM configuration determination system 105 utilizing at least in part its configuration training module 112, however, it is to be appreciated that in other embodiments the training dataset can be created by another system.

Step 202 includes obtaining data related to a VM configuration for an application. The application can be an existing application that is deployed using the VM configuration, for example. The data for the VM configuration may include statistics related to one or more of: memory (e.g., a percentage of consumption of RAM), storage (e.g., a percentage of consumption of one or more hard drives), fluctuations in traffic, failures (e.g., a number of failures), data unavailability, and data loss.

Step 204 includes determining whether the VM configuration satisfies one or more specification conditions. For example, the one or more specification conditions can include one or more thresholds for at least some of the statistics corresponding to the VM configuration data. If the VM configuration fails to satisfy the one or more specification conditions, then the VM configuration data is discarded at step 206, otherwise the process 200 continues to step 208.

Step 208 obtains and analyzes application data for the application. For example, step 208 can be performed by the source code parser 114 to obtain an application summary for the application.

Step 210 includes assigning a label to the application summary corresponding to the size of the VM configuration. For example, VM configurations can be divided into different groups, where each group represents a different VM size (e.g., extra small, small, medium, large, extra large). In such an example, it is assumed that a VM configuration in a group with a smaller size includes fewer computing resources than a VM configuration in a group with a larger size. In some embodiments, the number of groups can be adjusted depending on the number of VM configurations that are to be implemented. By way of example, the VM configurations can include a first VM configuration having a “small” amount of computing resources and a “small” amount of storage resources, a second VM configuration having a “small” amount of storage resources and a “medium” amount of storage resources, a third configuration having a “medium” amount of computing resources and a “small” amount of storage resources, etc. Thus, it is to be appreciated that the different groups can represent any number of VM configurations.

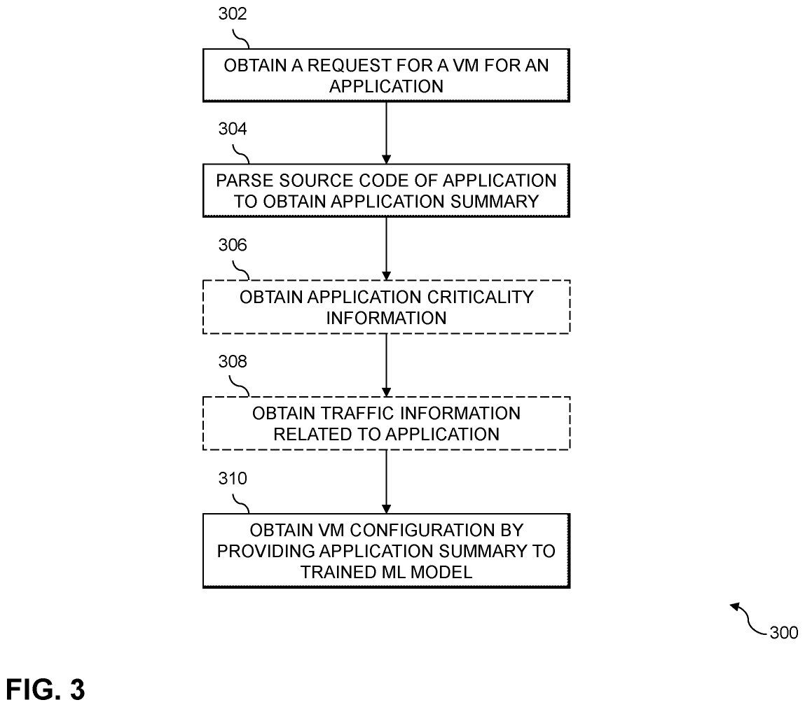

Step 212 creates and adds a record to the training dataset. The process 200 depicted in FIG. 2 can be repeated for multiple applications. Accordingly, each record in the resulting training dataset satisfies the one or more specification conditions and is assigned a label corresponding to the VM configuration and application data for the application. In some embodiments, the resulting training dataset can be used to train the ML model 118 to output one of the labels for a given application, as described in further detail below in conjunction with FIG. 3.

FIG. 3 shows a flow diagram of a process 300 for determining a VM configuration for an application in an illustrative embodiment. It is to be understood that this particular process 300 is only an example, and additional or alternative processes can be carried out in other embodiments.

In this embodiment, the process 300 includes steps 302 through 310, which are assumed to be performed by the VM configuration determination system 105 utilizing at least in part its configuration determination module 116.

Step 302 includes obtaining a request for a VM for an application. In some embodiments, the request may include aversion control repository link comprising source code of the application or a user can upload the source code.

Step 304 includes parsing the source code of the application to obtain an application summary. The application summary includes details of the application. Step 304 can be performed by the source code parser 114. For example, the source code parser 114 can be a lightweight parser that is configured to generate the application summary of the application in substantially real time. Step 304, in some embodiments, can identify a technology stack of the application based on a set of keywords and components. The application summary can include information related to one or more of: the technology stack, number of components of the application, a size of the application, and a type of the application.

Step 306 and/or Step 308 in FIG. 3 are optional (as indicated by the dashed lines). Step 306 includes obtaining criticality information (e.g., availability requirements and/or recovery requirements) for the application, and step 308 includes obtaining traffic information related to the application (e.g., predicted and/or historical traffic information). The information obtained at step 306 and/or step 308, in at least some embodiments, can be obtained from a CMDB and can be appended to the application summary.

Step 310 includes obtaining a VM configuration for the application by providing the application summary to the trained ML model 118. The VM configuration may be expressed, for example, in the form of a selected VM size label, as discussed above in conjunction with FIG. 2.

In at least some embodiments, the VM configuration obtained at step 310 is used to configure a VM for the application. Optionally, the VM can be configured in response to outputting an indication of the VM configuration to a user and obtaining approval from the user of the VM configuration.

By way of example, assume a user requests a VM for an application having the following features: (i) technology stack: NET v4.5 Framework; (ii) number and types of components: 2 Windows components, 1 web application component, 5 libraries, and 1 test project; (iii) application size: 125.7 MB; and (iv) type of application: monolithic. These features can be extracted at least in part by the source code parser 114 to generate the application summary. In some embodiments, the ML model 118 is configured to accept a dictionary containing such features as an input and to output the recommended VM size for the application. In the example above, the ML model 118 can output a “small” VM label for the application.

Some embodiments include training multiple ML models, where each trained ML model predicts a different type of resource. For example, a first ML model can be trained to predict a central processing unit (CPU) size, a second ML model can be trained to predict a storage size, and a third ML model can be trained to predict a graphics processing unit (GPU) size. In such an example, the outputs of the ML models can be combined to determine the VM configuration for a given application.

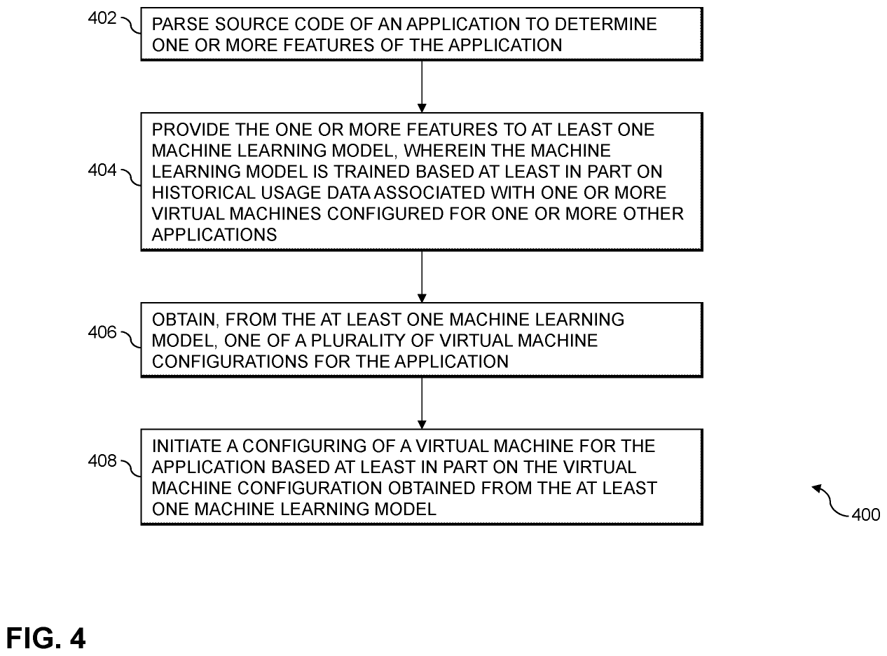

FIG. 4 is a flow diagram of a process 400 for determining a VM configuration based on application source code, in an illustrative embodiment. It is to be understood that this particular process 400 is only an example, and additional or alternative processes can be carried out in other embodiments.

In this embodiment, the process 400 includes steps 402 through 408. These steps are assumed to be performed by the VM configuration determination system 105 utilizing its elements 112, 114, 116, and 118.

Step 402 includes parsing source code of an application to determine one or more features of the application. Step 404 includes providing the one or more features to at least one machine learning model, wherein the machine learning model is trained based at least in part on historical usage data associated with one or more VMs configured for one or more other applications. Step 406 includes obtaining, from the at least one machine learning model, one of a plurality of VM configurations for the application. Step 408 includes initiating a configuration of at least one VM for the application based at least in part on the VM configuration obtained from the at least one machine learning model.

The one or more features may correspond to at least one of: one or more technology stacks corresponding to the application; a number of components of the application; a type of one or more components of the application; a type of the application; and a size of the application. The historical usage data may include one or more of: memory usage data, storage usage data, computing usage data, traffic data, and failure data. The parsing may be performed in response to a user request comprising a link to the source code of the application. The process 400 may include a step of retrieving the source code from a code repository based on the link in the user request. The process 400 may include a step of obtaining one or more additional features related to the application, wherein the one or more additional features comprise at least one of: a predicted traffic information corresponding to the application, historical traffic information corresponding to the application, one or more availability requirements of the application, and one or more recovery requirements of the application, wherein the machine learning model is further trained based at least in part on the at least one of the one or more additional features. The machine learning model may be trained using a supervised machine learning technique. The machine learning model may include at least one of: a boosted gradient model and a random forest of trees model. The process 400 may include a step of outputting an indication of the VM configuration obtained from the at least one machine learning model. The initiating may be performed in response to one or more user inputs approving the VM configuration obtained from the at least one machine learning model. The at least one machine learning model may be further trained based at least in part on application criticality data associated with at least one of the one or more other applications. The process may further include initiating a deployment of the application on the configured VM.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to significantly reduce errors and underutilized resources associated with VM configurations by automatically extracting one or more features of an application using an automated source code analysis and determining an accurate and customized VM configuration for the application by applying one or more machine learning techniques to the extracted features. These and other embodiments can effectively overcome technical problems associated with existing techniques where users often select VM configurations that may not be suitable for their respective applications, thereby leading to errors and/or underutilized compute resources.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a VM or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including VMs implemented using a hypervisor that runs on physical infrastructure. The cloud infrastructure further comprises sets of applications running on respective ones of the VMs under the control of the hypervisor. It is also possible to use multiple hypervisors each providing a set of VMs using at least one underlying physical machine. Different sets of VMs provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. VMs provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on VMs in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as VMs implemented using a hypervisor.

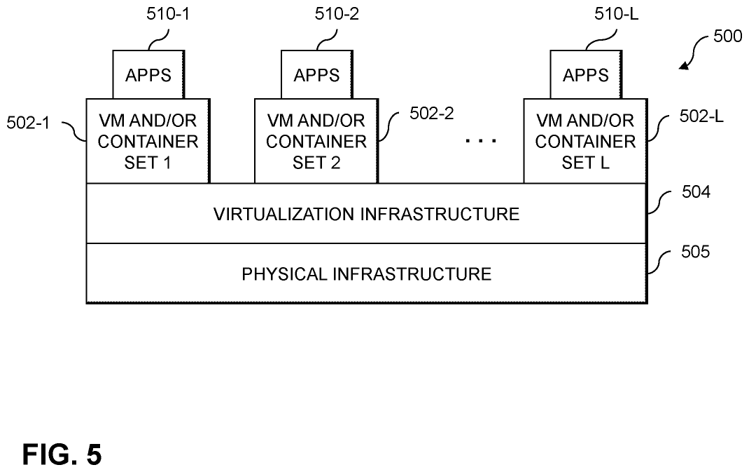

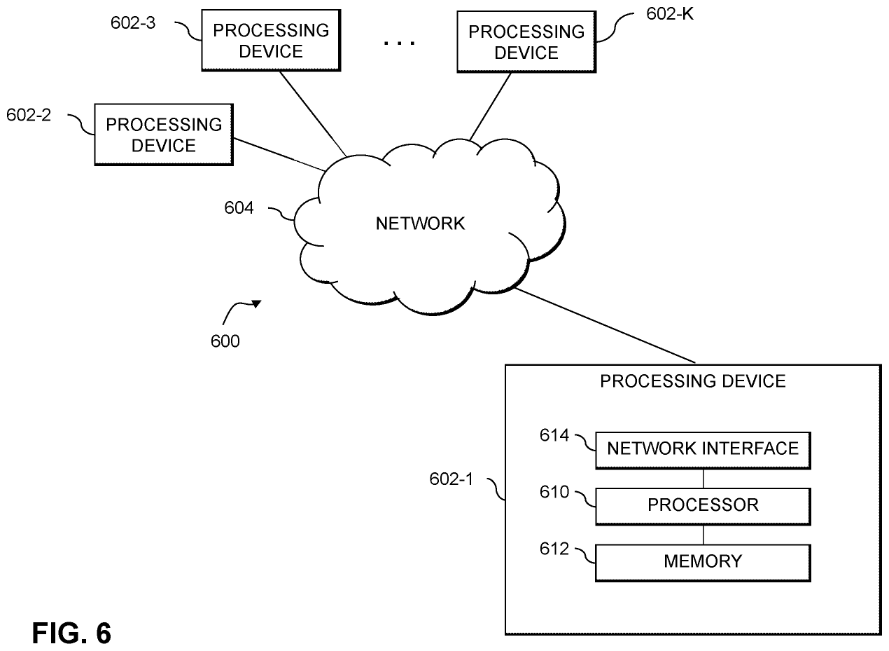

Illustrative embodiments of processing platforms will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple VMs and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a microcontroller, an ASIC, an FPGA or other type of processing circuitry, as well as portions or combinations of such circuitry elements.

The memory 612 comprises RAM, ROM or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising VMs. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
parsing source code of an application to determine one or more features of the application;
providing the one or more features to at least one machine learning model, wherein the machine learning model is trained based at least in part on historical usage data associated with one or more virtual machines configured for one or more other applications;
obtaining, from the at least one machine learning model, one of a plurality of virtual machine configurations for the application; and
initiating a configuration of at least one virtual machine for the application based at least in part on the virtual machine configuration obtained from the at least one machine learning model;
wherein the method is performed by at least one processing device comprising a processor coupled to a memory.

2. The computer-implemented method of claim 1, wherein the one or more features correspond to at least one of:
one or more technology stacks corresponding to the application;
a number of components of the application;
a type of one or more components of the application;
a type of the application; and
a size of the application.

3. The computer-implemented method of claim 1, wherein the historical usage data comprises one or more of: memory usage data, storage usage data, computing usage data, traffic data, and failure data.

4. The computer-implemented method of claim 1, wherein the parsing is performed in response to a user request comprising a link to the source code of the application.

5. The computer-implemented method of claim 4, further comprising:
retrieving the source code from a code repository based on the link in the user request.

6. The computer-implemented method of claim 1, further comprising:
obtaining one or more additional features related to the application, wherein the one or more additional features comprise at least one of: a predicted traffic information corresponding to the application, historical traffic information corresponding to the application, one or more availability requirements of the application, and one or more recovery requirements of the application, wherein the machine learning model is further trained based at least in part on the at least one of the one or more additional features.

7. The computer-implemented method of claim 1, wherein the machine learning model is trained using a supervised machine learning technique.

8. The computer-implemented method of claim 1, wherein the machine learning model comprises at least one of: a boosted gradient model and a random forest of trees model.

9. The computer-implemented method of claim 1, further comprising:
outputting an indication of the virtual machine configuration obtained from the at least one machine learning model.

10. The computer-implemented method of claim 9, wherein the initiating is performed in response to one or more user inputs approving the virtual machine configuration obtained from the at least one machine learning model.

11. The computer-implemented method of claim 1, wherein the at least one machine learning model is further trained based at least in part on application criticality data associated with at least one of the one or more other applications.

12. The method of claim 1, further comprising initiating a deployment of the application on the configured virtual machine.

13. A non-transitory processor-readable storage medium having stored therein program code of one or more software programs, wherein the program code when executed by at least one processing device causes the at least one processing device:
to parse source code of an application to determine one or more features of the application;
to provide the one or more features to at least one machine learning model, wherein the machine learning model is trained based at least in part on historical usage data associated with one or more virtual machines configured for one or more other applications;
to obtain, from the at least one machine learning model, one of a plurality of virtual machine configurations for the application; and
to initiate a configuration of at least one virtual machine for the application based at least in part on the virtual machine configuration obtained from the at least one machine learning model.

14. The non-transitory processor-readable storage medium of claim 13, wherein the one or more features correspond to at least one of:
one or more technology stacks corresponding to the application;
a number of components of the application;
a type of one or more components of the application;
a type of the application; and
a size of the application.

15. The non-transitory processor-readable storage medium of claim 13, wherein the historical usage data comprises one or more of: memory usage data, storage usage data, computing usage data, traffic data, and failure data.

16. The non-transitory processor-readable storage medium of claim 13, wherein the parsing is performed in response to a user request comprising a link to the source code of the application.

17. An apparatus comprising:
at least one processing device comprising a processor coupled to a memory;
the at least one processing device being configured:
to parse source code of an application to determine one or more features of the application;
to provide the one or more features to at least one machine learning model, wherein the machine learning model is trained based at least in part on historical usage data associated with one or more virtual machines configured for one or more other applications;
to obtain, from the at least one machine learning model, one of a plurality of virtual machine configurations for the application; and
to initiate a configuration of at least one virtual machine for the application based at least in part on the virtual machine configuration obtained from the at least one machine learning model.

18. The apparatus of claim 17, wherein the one or more features correspond to at least one of:
one or more technology stacks corresponding to the application;
a number of components of the application;
a type of one or more components of the application;
a type of the application; and
a size of the application.

19. The apparatus of claim 17, wherein the historical usage data comprises one or more of: memory usage data, storage usage data, computing usage data, traffic data, and failure data.

20. The apparatus of claim 17, wherein the parsing is performed in response to a user request comprising a link to the source code of the application.
